(19) United States
(12) Patent Application Publication
(10) Pub. No.: US 2006/0158970 A1
(43) Pub. Date: Jul. 20, 2006

(54) Method for controlling a dynamic system as well as a device suitable for carrying out such a method

(75) Inventor: Richard Adrianus Johannes Van Der Burg, Eindhoven (NL)

Correspondence Address: FOLEY AND LARDNER LLP;SUITE 500, 3000 K STREET NW, WASHINGTON, DC, 20007, US

(73) Assignee: Assembleon N.V.

(21) Appl. No.: 11/312,630

(22) Filed: Dec. 21, 2005

(30) Foreign Application Priority Data
Dec. 22, 2004 (NL) 1027851

(51) Int. Cl. G11B 7/00

(52) U.S. Cl. 369/44.11

(57) ABSTRACT

A system includes two guides that extend parallel to each other and a beam that extends transverse to the guides. The beam is movable over the guides, with a slide being movable over the beam. In controlling the system, a first difference is determined between desired and actual positions of the beam on the first guide. A second difference is determined between desired and actual positions of the beam on the second guide. A position difference between desired and actual positions of a point on the beam is determined on the basis of the first and second differences. A variation between the first and second differences is determined on the basis of the first and second differences. The force and torque to be exerted on the beam are determined at least in dependence on the position difference, variation, and position of the slide relative to the beam's center of mass.

### CROSS-REFERENCE TO RELATED PATENT APPLICATIONS

This application claims priority to, and hereby incorporates by reference, The Netherlands Patent Application No. 1027851, which was filed on Dec. 22, 2004.

### BACKGROUND

The invention relates to a method for controlling a dynamic system comprising two guides that extend parallel to each other and a beam that extends transverse to the guides. The beam is movable over the guides, with a slide being movable over the beam. The invention also relates to a device suitable for carrying out such a method.

The control of such a dynamic system is known, for example from U.S. Pat. No. 6,163,116. The advantage of moving a beam over two guides that extend parallel to each other is that a higher degree of stability can be obtained in this manner as compared to a situation in which the beam is moved over only one guide. Such a relatively high degree of stability is desirable in component placement machines, for example, in which the slide that is movable over the beam is provided with a nozzle for picking-up components and subsequently placing the picked-up component at the desired position on, for example, a printed circuit board.

A drawback of conventional systems and methods is that duel motors, which are respectively associated with the parallel guides, have motor controllers that negatively interact with each other. To obviate this problem, the method according to U.S. Pat. No. 6,163,116 proposes using a new coordinate system with two decoupled axes, which are a linear axis and a rotary axis. A drawback of this solution, however, is that it requires relatively complex control loops. In addition, the method according to this solution leads to virtual coordinates. Further, with the device according to this solution, rotation is not directly available as a degree of freedom and, therefore, the device it is not certainly controlled.

### SUMMARY

A first object of the invention is to provide a method by means of which the movement of the beam over the guides can be controlled in a relatively simple manner, while the controllers hardly influence one another.

This object is accomplished with a method according to the invention. A first difference is determined between a desired position and an actual position of the beam on the first guide. A second difference is determined between a desired position and an actual position of the beam on the second guide. A position difference between a desired position and an actual position of a specific point on the beam is determined on the basis of the first and second differences. A variation between the first difference and the second difference is furthermore determined on the basis of the first and second differences. Subsequently, the force and the torque to be exerted on the beam are determined at least in dependence on the position difference, the variation, and the position of the slide relative to the center of mass of the beam.

It has been found that the force and the torque to be exerted on the beam can be determined in a simple manner on the basis of the position difference and the variation at a specific point, e.g., the center of mass of the beam or the position of the beam at the location of the slide. The force and the torque to be exerted on the beam can easily be converted into forces to be exerted on the slide at the location of the first and the second guide.

According to one embodiment of the method according to the invention, the position difference is corrected in dependence on the position of the slide relative to the specific point on the beam. Subsequently, the corrected position difference is supplied to a first controller for determining the force to be exerted on the beam. In this way, the force to be exerted on the beam is determined in part in dependence on the position of the slide relative to the beam. The position of the center of mass of the beam and the slide present thereon will change as a result of the movement of the slide over the beam. The force to be exerted on the slide can be determined with even greater precision by taking this into account.

According to another embodiment of the method according to the invention, the variation is supplied to a second controller for determining a torque, which torque is corrected in dependence on the position of the slide relative to the center of mass of the beam. The corrected torque is then exerted on the slide. As a change in the position of the center of mass of the beam and the slide present thereon is taken into account in the determination of the torque, the torque to be exerted on the slide can be determined with greater precision.

According to another embodiment of the method according to the invention, the forces to be exerted on the slide at the location of the first and the second guide are determined in dependence on the force or torque to be exerted on the slide. In this way, it will be relatively easy to subsequently control the motors to drive the beam over the guides.

According to another embodiment of the method according to the invention, the correction of the position difference and the slide torque respectively take place in dependence on the difference between the position of the center of mass of the beam with the slide present thereon and the position the center of mass of the beam. In this way, the actual position of the center of mass of the beam in combination with the slide is taken into account.

According to another embodiment of the method according to the invention, the correction of the position difference and the slide torque respectively take place in dependence on the difference between the position of the center of mass of the slide and the position of the center of mass of the beam. In this way, a change in the position of the center of mass of the slide is taken into account. The center of mass of the beam will only shift in a direction parallel to the guides. The position of the center of mass will remain unchanged in the direction parallel to the beam.

A second object of the present invention is to provide a device suitable for carrying out such a method.

This second object is accomplished by a device according to the present invention. The device comprises two guides that extend parallel to each other and a beam that extends transverse to the guides. The beam is movable over the guides, with a slide being movable over the beam. Means are provided for determining a first difference between a desired position and an actual position of the beam on the first guide. Means are also provided for determining a second difference between a desired position and an actual position of the beam on the second guide. Means are also provided for determining a position difference between a desired position and an actual position of a specific point on the beam on the basis of the first and second differences. Means are also provided for determining a variation between the first difference and the second difference on the basis of the first and second differences. Means are also provided for determining the force and the torque to be exerted on the beam in dependence at least on the position difference, the variation, and the position of the slide relative to the center of mass of the beam. Finally, means are also provided for exerting the force and the torque as determined on the beam. Using such a device, it is relatively easy to move a slide to any desired position with a high degree of precision.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 is a schematic top plan view of a dynamic system according to the present invention; and

FIG. 2 is a schematic representation of a control circuit for the dynamic system that is shown in FIG. 1.

### DETAILED DESCRIPTION

Efforts have been made throughout the drawings to use the same or similar reference numerals for the same or like components.

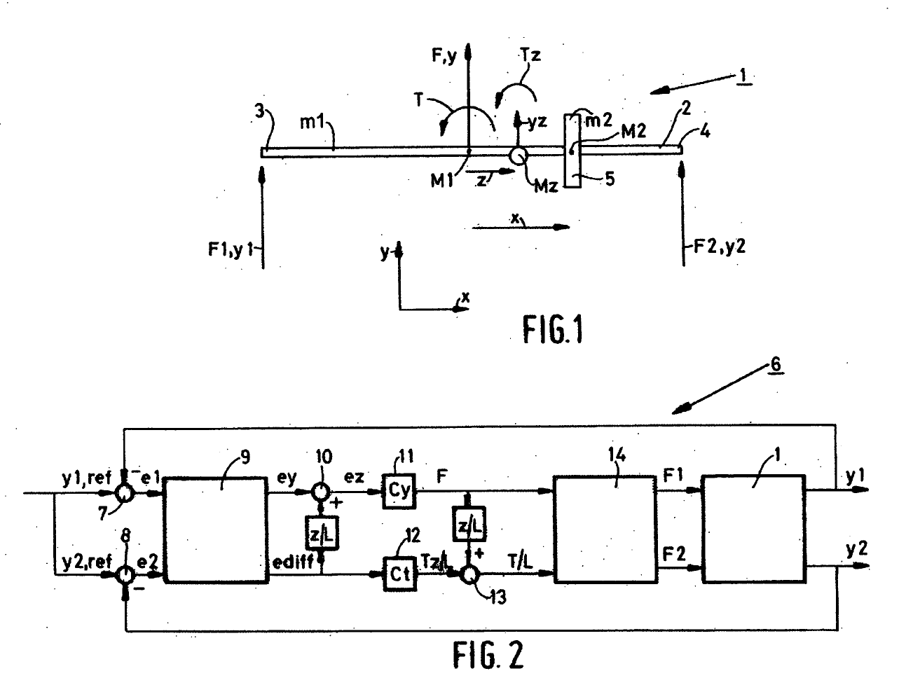

FIG. 1 shows a dynamic system 1, which comprises a beam 2 that extends in the X-direction. The beam 2 is movably supported with its ends 3, 4 on parallel guides (not shown) that extend in the Y-direction. A slide 5 is movably supported on the beam 2. A movement of the beam 2 over the guides and of the slide 5 over the beam 2 is effected by means of motors.

A force is exerted on the slide 5, as a result of which the slide 5 is moved to a position X. A force F1 is exerted on the first end 3 of the beam 2 by means of motors that co-act with the guides, as a result of which the first end 3 of the beam 2 is moved to a position y1. In a similar manner, a force F2 is exerted on the second end 4 of the beam 2, as a result of which the second end 4 of the beam 2 is moved to a position y2. The total force F exerted on the beam 2 and the slide 5 in the Y-direction is, therefore, the sum of the forces F1 and F2, as follows:
F=F1+F2 (1)
Further, the movement y of the center of the beam 2 equals the average of the movements y1 and y2, as follows:
y=(y1+y2)/2 (2)

The beam 2 has a mass m1 whose center of mass M1 is located in the center of the beam 2. The slide 5 has a mass m2 whose center of mass M2 is located in the center of the slide 5. The center of mass Mz of the beam 2 in combination with the slide 5 will be located between the centers of mass M1, M2 of the beam 2 and the slide 5, respectively.

The center of mass Mz is spaced from the center M1 of the beam 2 by a distance z, which distance z depends on the masses m1, m2. The distance z can be determined as follows:

$$z = \frac{m2}{( m1 + m2 )} x \qquad ( 3 )$$

The movement yz of the center of mass Mz in the Y-direction depends both on the movement y1 and on the movement y2. The actual positions y1, y2 of the ends 3, 4 of the beam 2 are sensed by means of sensors. Consequently, if the length of the beam 2 is 2L, the torque Tz that is exerted on the beam 2 in the center of mass Mz is:
(F2−F1)L−z(F1+F2)=T−(F)(z)=Tz (4)

FIG. 2 shows a control circuit for carrying out the method according to the invention, which control circuit is integrated in a control system for controlling the motors for moving the ends 3, 4 of the beam 2 as well as the slide 5.

The desired positions y1,ref and y2,ref of the first and the second ends 3, 4 of the beam 2 are supplied to the control circuit 6. A subtracter 7 determines the first difference e1 between the desired position y1,ref and the actual position y1 of the first end 3 of the beam 2. In a similar manner, a subtracter 8 determines the second difference e2 between the desired position y2,ref and the actual position y2 of the second end 4 of the beam 2.

The two differences e1, e2 are supplied to a processing unit 9, in which the differences e1, e2 are converted in accordance with the formula below into a position difference ey that indicates the difference between the desired position of the center of mass M1 of the beam 2 and the actual position of the center of mass M1 of the beam 2.

$$\vert \begin{matrix}ey \\ \\ ediff\end{matrix} \vert = \vert \begin{matrix}0.5 & & 0.5 \\ & & \\ - 0.5 & & 0.5\end{matrix} \vert \cdot \vert \begin{matrix}e1 \\ \\ e2\end{matrix} \vert \qquad ( 5 )$$

Furthermore, the variation ediff is determined by means of the processing unit 9. The variation ediff will be zero if the first difference e1 equals the second difference e2.

The variation ediff is subsequently multiplied by z/L and supplied to an adder 10, in which it is added to the position difference ey. This gives a value ez, which indicates a value for the difference between the desired position and the actual position of the center of mass Mz in the Y-direction. The value ez is subsequently supplied to a first controller 11, which may comprise a PID-controller, for example, supplemented with certain filters, if desired. The controller 11 is used for determining the force F that is to be exerted on the beam 2.

While the value ez is supplied to the controller 11, the variation ediff is supplied to a second controller 12, which may have the same structure as the controller 11. Using the controller 12, a force Tz/L is determined from the variation ediff, which force is a measure of the torque to be exerted on the beam 2.

In an adder 13, a part z/L of the force F as determined by means of the controller 11 is added to the force Tz/L. This gives a force T/L, which force is a measure of a torque to be exerted on the beam 2.

Both the force F determined by means of the controller 11 and the force T/L are supplied to a processing unit 14, in which the forces F1, F2 to be exerted on the ends 3, 4 of the beam 2 are determined by means of the formula below.

$$\vert \begin{matrix}F1 \\ \\ F2\end{matrix} \vert = \vert \begin{matrix}0.5 & & - 0.5 \\ & & \\ 0.5 & & 0.5\end{matrix} \vert \cdot \vert \begin{matrix}F \\ \\ T / L\end{matrix} \vert \qquad ( 6 )$$

The forces F1, F2 are then transmitted to the ends 3, 4 of the beam 2 by means of the motors, causing the ends 3, 4 to move over the guides in question and subsequently occupy positions y1, y2. The positions y1, y2, which can be sensed by means of sensors, are subsequently fed back to the subtracters 7, 8.

As the controllers 11, 12 function independently of each other, they will not influence each other. It is also possible to multiply ediff by x/L rather than by z/L, resulting in a value ex, which will subsequently be supplied to the controller 11. The value ex is a measure of the difference of the center of mass M2 of the slide 5 in the Y-direction.

The forces may be applied to the center of mass. In addition, it is possible to configure the control circuit 6 as an MIMO controller (Multi Input Multi Output), wherein a minimal interaction takes place between the two control loops for the two Y-drive units.

Given the disclosure of the present invention, one versed in the art would appreciate that there may be other embodiments and modifications within the scope and spirit of the invention. For example, the method and the device according to the invention are suitable for various applications in which a slide 5 is to be precisely positioned, such as in a component placement machine. Accordingly, all modifications attainable by one versed in the art from the present disclosure within the scope and spirit of the present invention are to be included as further embodiments of the present invention. The scope of the present invention is to be defined as set forth in the following claims.

What is claimed is:

1. A method for controlling a dynamic system that includes two guides that extend parallel to each other and a beam that extends transverse to the guides, which beam is movable over the guides, with a slide being movable over the beam, the method comprising the steps of:
determining a first difference between a desired position and an actual position of the beam on the first guide;
determining a second difference between a desired position and an actual position of the beam on the second guide;
determining a position difference between a desired position and an actual position of a specific point on the beam on the basis of the first and second differences;
determining a variation between the first difference and the second difference on the basis of the first and second differences;
determining a force and a torque to be exerted on the beam at least in dependence on the position difference, the variation, and the position of the slide relative to a center of mass of the beam.

2. The method according to claim 1, further comprising the steps of:
correcting the position difference in dependence on the position of the slide relative to the specific point on the beam; and
supplying the corrected position difference to a first controller for determining the force to be exerted on the beam.

3. The method according to claim 2, further comprising the steps of:
supplying the variation to a second controller for determining a slide torque;
correcting the slide torque in dependence on the position of the slide relative to the center of mass of the beam; and
exerting the slide torque on the slide.

4. The method according to claim 1, further comprising the step of:
determining, in dependence on a force or torque to be exerted on the slide, the forces to be exerted on the slide at the location of the first and the second guide.

5. The method according to claim 3, further comprising the step of:
determining, in dependence on slide torque, the forces to be exerted on the slide at the location of the first and the second guide.

6. The method according to claim 3, wherein the correction of the position difference and the correction of the slide torque respectively take place in dependence on the difference between the position of the center of mass of the beam with the slide present thereon and the position of the center of mass of the beam.

7. The method according to claim 3, wherein the correction of the position difference and the correction of the slide torque respectively take place in dependence on the difference between the position of a center of mass of the slide and the position of the center of mass of the beam.

8. A system comprising:
two guides that extend parallel to each other;
a beam that extends transverse to the guides, which beam is movable over the guides;
a slide that is movable over the beam;
means for determining a first difference between a desired position and an actual position of the beam on the first guide;
means for determining a second difference between a desired position and an actual position of the beam on the second guide;
means for determining a position difference between a desired position and an actual position of a specific point on the beam on the basis of the first and second differences;
means for determining a variation between the first difference and the second difference on the basis of the first and second differences;
means for determining a force and a torque to be exerted on the beam in dependence at least on the position difference, the variation, and the position of the slide relative to the center of mass of the beam; and
means for exerting the force and the torque as determined on the beam.
